(19) United States
(12) Patent Application Publication
(10) Pub. No.: US 2017/0082221 A1
(43) Pub. Date: Mar. 23, 2017

(54) AIRCRAFT BLEEDING DUCT IN COMPOSITE MATERIAL RELATED APPLICATION

(71) Applicant: Airbus Defence and Space S.A., Getafe (ES)

(72) Inventors: Francisco Jose REDONDO CARRACEDO, Getafe (ES); Sergio TEJEDOR FOGUET, Getafe (ES); Cesar BAUTISTA DE LALLAVE, Getafe (ES); Zulima MARTIN MORENO, Getafe (ES); Pedro NOGUEROLES VINES, Getafe (ES); Bernardo LOPEZ ROMANO, Getafe (ES); Sofia DELGADO, Getafe (ES)

(21) Appl. No.: 15/272,989

(22) Filed: Sep. 22, 2016

(30) Foreign Application Priority Data
Sep. 22, 2015 (EP) 15382458.6

(51) Int. Cl. F16L 9/14; F02C 7/18

(52) U.S. Cl. CPC F16L 9/14; F02C 7/18

(57) ABSTRACT

Non-straight ducts for conducting fluids at temperatures higher than 280° C. and pressures higher than 4 bar made of a composite material and, particularly, hot air bleed ducts of an aircraft made of a carbon-fiber reinforced polymer aimed to reduce weight of the bleeding system by replacing most of the metallic material from which the bleeding ducts are currently made.

### RELATED APPLICATION

This application claims priority to European Patent Application No. 15382458.6, filed Sep. 22, 2015, which is incorporated by reference in its entirety.

### FIELD OF THE INVENTION

The present invention relates to non-straight ducts for conducting fluids at high temperatures and pressures made of composite material and more particularly to hot air ducts belonging to the bleed system of an aircraft.

### BACKGROUND

Hot air bleed ducts of an aircraft are formed to meet the following basic requirements: (i) service work conditions of an operating temperature of 230° Celsius, and operating pressure of 4 bar: (ii) thermal stability at service work conditions, (iii) thermal stability in case of thermal excursions of 30 seconds (s) to 60 s at 260° C. or 5 s at 290° C.; (iv) no weight loss at operating temperature during service life; (v) no outgassing release of dust and/or toxic elements at operating temperature; (vi) no degradation of properties due to long term exposure, and (vii) appropriate fire/smoke/toxicity (FST) behavior at operating temperature.

Other requirements that should be met by hot bleed ducts are: (i) no permanent deformation or leaks are allowed at operating pressure; no permanent deformations or leaks are allowed at a proof pressure of one and a half (1.5) times operating pressure; no breaks, permanent deformations or leaks are allowed at a burst pressure of three (3) times operating pressure; metallic welding/bonding/assembly tolerance; transmitted loads and vibrations tolerance; and no toxicity (when handling or storage).

The hot air bleed ducts of an aircraft are typically made of titanium and/or steel. Titanium and/or steel ducts comply with the above-mentioned requirements as well as with the required structural and airtight properties. The main disadvantage of the titanium and/or steel hot air ducts is the weight. An additional disadvantage of titanium hot air bleed ducts is that their typical thin thickness makes them easily deformed in assembly operations.

Ducts made of composite material are known in the art such as commercially available ducts of thermosetting resins, mostly epoxy and phenolic resins, which are produced in most of the cases through filament winding or hand lay-up of fabrics. The typical service temperature of these ducts range between 120° C.-200° C. (230° C. in the case of bismaleimide resins).

Oil and gas industries are staring to use composite pipes for drilling oil and gas in ultra-deep seawater and for hydraulic fracturing (fracking). In this case, the pipes are produced by extrusion or filament winding with different thermoplastic matrixes depending on the specific use: polypropylene (PP), polyethylene (PE), polyamide (PA), polyether-ether-ketone (PEEK), polyvinylidene fluoride (PVDF). The service temperatures of these ducts range between 80° C.-200° C. The geometry is simple, straight or with gentle radius of curvature.

None of these ducts are suitable composite alternatives to the titanium/steel hot air bleed ducts. First of all, their service temperature are below the required temperature (or in the limit). Secondly, to meet the rest of the requirements (such as Fire, Smoke and Toxicity (FST)) a multi-layer design should be employed to add these properties, which would penalize the benefit in terms of weight savings. Besides, all commercially available composite ducts are straight ducts while the hot air bleed ducts have complex geometries (see FIG. 1).

### SUMMARY OF THE INVENTION

The invention made by the inventors and disclosed may be embodied as non-straight ducts, e.g., curvilinear, for conducting fluids, e.g., hot bleed air, at temperatures higher than 280° C. and pressures higher than 4 bar made of a composite material comprising layers of a carbon fiber fabric and a high temperature resin injected or infused in said layers. The carbon fiber fabric may be a braided carbon fiber fabric and the high temperature resin is a phenylethinyl-terminated imide which is injected or infused in a temperature range of 280-290° C. and in a pressure range of 12-13 atmosphere (atm).

The invention may also be embodied as an aircraft bleeding system comprising at least one of said non-straight ducts, e.g., curvilinear, in the hot air subsystem aimed to reduce weight of the bleeding system by replacing ducts currently made of titanium or steel. The ducts may be included in a bleeding system associated with an aircraft propulsion system. In particular, the ducts may convey hot, pressurized air extracted from the compressor of a jet engine and ducted for use in the aircraft.

The invention may be embodied as a method for bleeding hot gases in an aircraft using non-straight ducts made of a composite material comprising layers of a carbon fiber fabric and a high temperature resin injected or infused in said layers instead of ducts made of a metallic material.

The invention may be embodied as a method to form a duct for conveying hot, pressurized gases to be used in a pneumatic bleed air system of an aircraft, the method comprising: forming a passage for the hot, pressurized gases by assembling layers of a braided carbon fiber fabric into a duct to form an outer boundary of the passage, infusing the assembled layers with a phenylethinyl-terminated imide resin, and curing the assembly of layers with the phenylethinyl-terminated imide resin to form the duct.

Other desirable features and advantages of this invention will become apparent from the subsequent detailed description of the invention and the appended claims, in relation with the enclosed drawings.

### BRIEF DESCRIPTION OF THE DRAWINGS

FIG. 1 is a perspective view of the pneumatic bleed air system of an aircraft.

FIG. 2 is a perspective view of a hot air bleed duct prototype according to the invention

FIG. 3 illustrates an aircraft having a gas turbine engine from which bleed air is extracted for passage through the hot air bleed duct.

### DETAILED DESCRIPTION

Achieving a hot air bleed duct made of a composite material requires finding a suitable resin meeting its service requirements, such as those mentioned in the Background, and an appropriate processing method that allows its manufacturing.

There are a few theoretical suitable resins for high-temperature applications such as those disclosed in U.S. Pat. No. 6,359,107 “Composition of and method for making high performance resins for infusion and transfer molding processes”. On the other hand pre-impregnated materials could be used in filament winding manufacturing processes for complex geometries.

The inventors have conceived a suitable combination for a hot air bleed duct comprising, for example, a braided carbon fiber fabric as fibrous reinforcement; and a phenylethynyl-terminated imide as resin. They also conceived of a resin injection/infusion method to manufacture the hot air bleed duct.

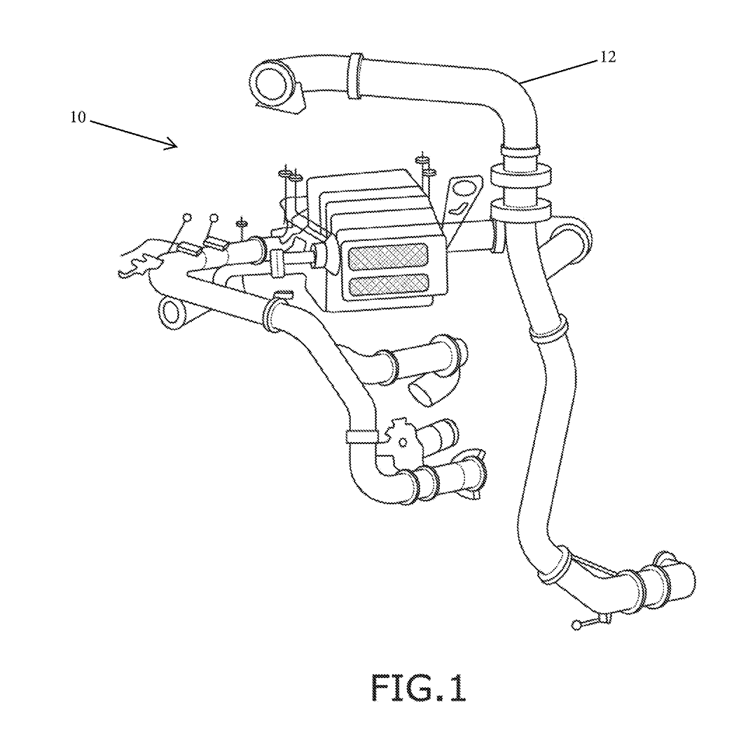

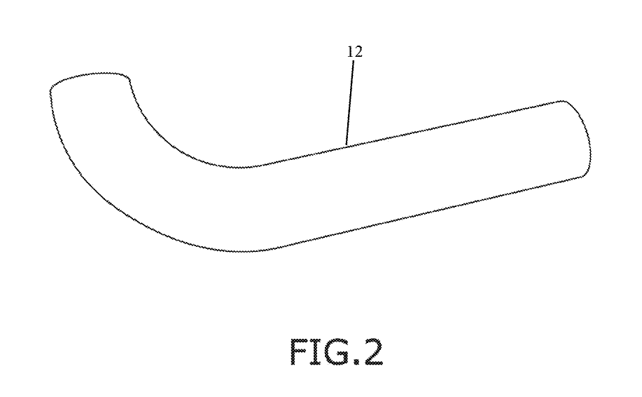

FIG. 1 shows a pneumatic bleed air system 10 of an aircraft that includes one or more hot air bleed ducts 12 for hot air, such as compressed air extracted from the compressor section of one or more of the jet engines that propel the aircraft. FIG. 2 shows, in an enlarged view, a hot air bleed duct 10 that is formed from a composite material that includes braided carbon fiber fabric and a resin that may be a phenylethynyl-terminated imide.

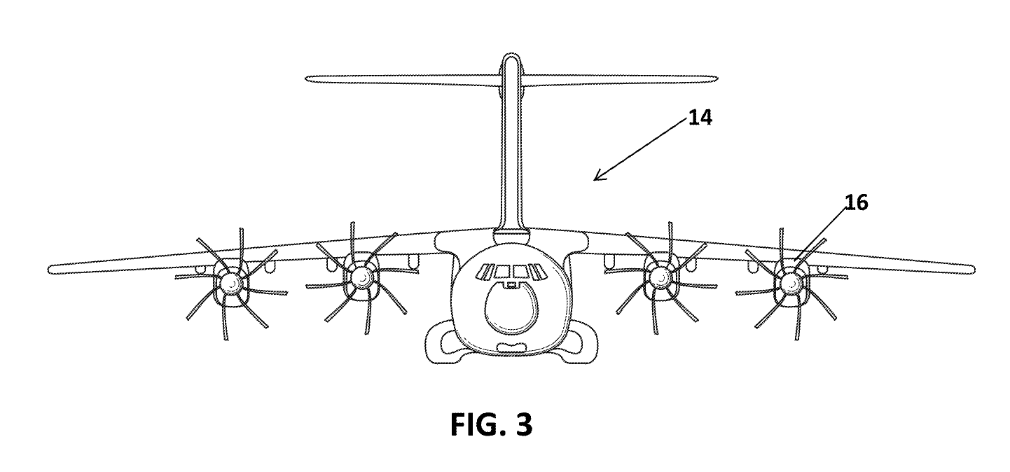

FIG. 3 shows an aircraft 14 having four turbo-prop gas turbine engines 16 each having a compressor. Pressurized air is extracted, e.g., bled, from the compressor of one or more of the engines and conveyed by hot air bleed ducts through the pneumatic bleed air system for the aircraft, such as shown in FIG. 1. The ducts 12 may form a network of ducts extending from one or more of the engines to various components of the aircraft requiring compress air for pneumatic operation or cabin pressurization.

The braided carbon fiber fabric is a reinforcement with good internal adaptability to complex geometries (drapping), and thus, tightness of the duct, better support of the structure and greater retention of duct design dimensional tolerances. Fiber distortion associated to complex geometry has been characterized and validated. The braiding (deviation in the original orientation of the fibers in the fabric) is distorted because, prior to injection of the resin. The braiding is used to remove the “sizing” (1-2 hrs. at 400° C.) to avoid porosity problems during the process to remove the sizing tissue. To assess the effect of the slight distortion of fibers in ducts of complex geometry shear tests (IPSS) were performed reproducing the distortion of the braiding (laminated to ±60° instead of ±45 degrees), and found that this does not impact on the mechanical behavior of the laminate.

The phenylethynyl-terminated imide resin has a glass transition temperature (Tg) of 330° C., a service temperature ranging 290-315° C., and an excellent thermo-oxidative behavior in that it does not release volatiles or lose weight in service conditions. For the study of the Thermo Oxidative Stability (TOS) coupons at the service temperature (230° C.) were aged monitoring the weight loss (and dimensional change) up to 2000 hrs. The behavior of the material was pretty good and the total weight loss observed after 2000 hrs. at 230° C. is below 0.8% (with no significant changes in dimensions, width or thickness). Coupons were aged also at the “excursion” temperatures (260 & 290° C.) during 100 hrs. the weight loss in these cases were below 0.6 & 0.9 respectively. The Outgassing Identification (OI) was carried out by TG-FTIR. A dynamic scan from 300 to 1000° C. (10° C./min) and an isothermic scan at 300° C. during 10 hs was done. No release of volatiles occurred below 300° C. (or if it happened, the quantity was so small that was below the detection limit of the FTIR).

A Resin Transfer Molding (RTM) method was selected as a convenient manufacturing method in an industrial environment given the complexity of the geometry and the sealing requirements of hot air bleed ducts.

A prototype of the hot air bleed duct 12 was manufactured with a 90° elbow and with a braided carbon fiber fabric product marketed as T650-35 by A&P Technology. The resin used to manufacture the prototype of the duct 12 was a phenylethynyl-terminated imide marketed as PETI-330 by UBE Industries LDT. The RTM method used to make the prototype of the duct was adapted to the high viscosity of the phenylethynyl-terminated imide resin (3 orders of magnitude greater than the standard injection resins, RTM6 type), to the high temperatures of the process (injection at 280° C., curing at 370° C.) and to a constant pressure of 12-13 atm. A special assembly for manufacturing the prototype was prepared to meet these and other requirements.

The structural analysis of the prototype of the duct was done by a finite element model (ABAQUS) resulting in a duct thickness of 1.08 mm (4 layers of braided carbon fiber fabric). The density of the prototype material is about 1.6×10−6 kg/mm3. Commonly, the current hot air bleed ducts of a titanium alloy have a density 4.5×10−6 kg/mm3 and a thickness of 0.7 mm. Therefore, the prototype represents a weight saving of 45% with respect to a duct formed of a titanium alloy. While the prototype of the duct does not include coupling elements, joints, terminals, connections and unions that may be included with a hot air bleed duct used in an aircraft, the analysis of the prototype indicates that forming a hot air bleed duct from a composite material would achieve a 30 percent weight savings as compared to a hot air bleed duct formed of a titanium allow.

The prototype of the duct underwent a pressure test was and the duct exceeded the explosion pressure required, 12 bar, (the test was continued up to 26 bar).

Although the present invention has been described in connection with various embodiments, it will be appreciated from the specification that various combinations of elements, variations or improvements therein may be made, and are within the scope of the invention as defined by the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

The invention is:

1. A non-straight duct for conducting fluids at temperatures higher than 280° C. and pressures higher than 4 bar made of a composite material comprising layers of a braided carbon fiber fabric and a high temperature phenylethinyl-terminated imide resin injected or infused in said layers.

2. The non-straight duct according to claim 1, wherein the high temperature resin is injected or infused in a temperature range of 280-290° C. and in a pressure range of 12-13 atm.

3. An aircraft bleeding system comprising one or more of the non-straight ducts recited in claim 1.

4. An aircraft propulsion system comprising a bleeding system recited in claim 1.

5. A method comprising bleeding hot gases in an aircraft using one or more non-straight ducts made of a composite material comprising layers of braided carbon fiber fabric and a high temperature phenylethinyl-terminated imide resin injected or infused in said layers.

6. The method of claim 5 wherein the carbon fiber fabric is a braided carbon fiber fabric and the high temperature resin is a phenylethinyl-terminated imide.

7. The method according to claim 6, wherein the high temperature resin is injected or infused in a temperature range of 280-290° C. and in a pressure range of 12-13 atm.

8. A hot air bleed duct comprising:
a passage configured for hot gases having a temperature greater than 280° C. and pressures higher than 4 bar; and
a duct defining the passage formed of a composite material comprising layers of a braided carbon fiber fabric and a phenylethinyl-terminated imide resin injected or infused in said layers,
wherein the duct includes at least one section which is curved or bent.

9. The hot air bleed duct of claim 8 wherein the passage is in an aircraft and in fluid communication with a compressor of a gas turbine engine mounted to the aircraft.

10. A method to form a duct for conveying hot, pressurized gases to be used in a pneumatic bleed air system of an aircraft, the method comprising:
forming a passage for the hot, pressurized gases by assembling layers of a braided carbon fiber fabric into a duct to form an outer boundary of the passage;
infusing the assembled layers with a phenylethinyl-terminated imide resin, and
curing the assembly of layers with the phenylethinyl-terminated imide resin to form the duct.

11. The method of claim 10 wherein the duct is curvilinear along a length of the duct.
